(19) United States
(12) Patent Application Publication
(10) Pub. No.: US 2006/0205899 A1
(43) Pub. Date: Sep. 14, 2006

(54) Catalyst systems of the ziegler-natta type and a process for preparing them

(76) Inventor: Klaus Fottinger, Kelkheim (DE)

Correspondence Address: NOVAK DRUCE DELUCA & QUIGG, LLP, 1300 EYE STREET NW, SUITE 400 EAST TOWER, WASHINGTON, DC, 20005, US

(21) Appl. No.: 10/553,230

(22) PCT Filed: Apr. 14, 2004
(86) PCT No.: PCT/EP04/03898

§ 371 Date: Oct. 14, 2005

Related U.S. Application Data
(60) Provisional application No. 60/474,417, filed on May 30, 2003.

(30) Foreign Application Priority Data
Apr. 15, 2003 (DE) 103 17 398.6

(51) Int. Cl. C08F 4/44; B01J 31/00

(52) U.S. Cl. 526/124.3; 526/129; 502/103; 502/118

(57) ABSTRACT

The present invention relates to catalyst systems of the Ziegler-Natta type, to a process for preparing them, to their use for the polymerization of olefins and to ethylene copolymers which can be prepared using this catalyst system.

The present invention relates to catalyst systems of the Ziegler-Natta type, to a process for preparing them and to their use for the polymerization of olefins.

Catalyst systems of the Ziegler-Natta type have been known for a long time. These systems are used, in particular, for the polymerization of C₂-C₁₀-alk-1-enes and comprise, inter alia, compounds of polyvalent titanium, aluminum halides and/or aluminum alkyls together with a suitable support material. The preparation of the Ziegler-Natta catalysts usually occurs in two steps. The titanium-containing solid component is prepared first and is subsequently reacted with the cocatalyst. The polymerization is subsequently carried out using the catalysts obtained in this way.

When oxidic support materials are used, a magnesium compound is usually applied to the support first and the titanium component is added in a later step. Such a process is disclosed, for example, in EP-A-594915.

Only few processes in which the titanium component is added first and the magnesium compound is added subsequently have been described.

WO 99/46306 discloses a process for preparing Ziegler-Natta catalysts in which a silica gel is silylated, subsequently brought into contact with a titanium compound and the intermediate obtained in this way is reacted with an alkyl magnesium alkoxide.

A further process for preparing Ziegler-Natta catalysts is disclosed in EP-A-027733, in which an oxidic support material is brought-into contact with a titanium compound, the intermediate obtained in this way is reacted with an alkyl magnesium compound, and a reagent selected from the group consisting of hydrogen chloride, hydrogen bromide, water, acetic acid, alcohols, carboxylic acids, phosphorus pentachloride, silicon tetrachloride, acetylene and mixtures thereof is subsequently added.

It is an object of the present invention to develop a Ziegler catalyst which displays a high productivity and displays good comonomer incorporation behavior. The comonomer incorporation behavior of various catalyst systems is indicated at a constant ratio of ethylene to comonomer in the reactor by the formation of copolymers having a relatively low density. Furthermore, the copolymers formed should have a low content of extractable material, especially in the low density range. Copolymers which have been prepared by means of a Ziegler catalyst usually display, especially at densities in the range from 0.91 to 0.93 g/cm³, quite high proportions of extractable, i.e. low molecular weight, material.

We have found that this object is achieved by a process for preparing catalyst systems of the Ziegler-Natta type, which comprises the following steps:
A) bringing an inorganic metal oxide into contact with a tetravalent titanium compound and
B) bringing the intermediate obtained from step A) into contact with a magnesium compound MgR¹ₙX¹₂₋ₙ; where X¹ are each, independently of one another, fluorine, chlorine, bromine, iodine, hydrogen, NR^{X}₂, OR^{X}, SR^{X}, SO₃R^{X} or OC(O)R^{X}, and R¹ and R^{X} are each, Independently of one another, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl and n is 1 or 2, and
C) bringing the intermediate obtained from step B) into contact with a halogenating reagent of the formula R^{Y}ₛ-E-Y₄₋ₛ, where R^{Y} are each, independently of one another, hydrogen, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl, E is carbon or silicon, Y is fluorine, chlorine, bromine or iodine and s is 0, 1, 2 or 3 when E is carbon and s is 1, 2 or 3 when E is silicon.

The invention further provides catalyst systems of the Ziegler-Natta type which can be prepared by the process of the present invention, prepolymerized catalyst systems and a process for the polymerization or copolymerization of olefins at from 20 to 150° C. and pressures of from 1 to 100 bar, wherein the polymerization of copolymerization is carried out in the presence of at last one catalyst system according to the present invention and, if appropriate, an aluminum compound as cocatalyst.

As inorganic metal oxide, use is made of, for example, silica gel, aluminum oxide, hydrotalcite, mesoporous materials and aluminosilicate, in particular silica gel.

The inorganic metal oxide can have been partially or fully modified prior to the reaction in step A). The support material can, for example, be treated at from 100 to 1000° C. under oxidizing or non-oxidizing conditions, if desired in the presence of fluorinating agents such as ammonium hexafluorosilicate. The water and/or OH group content, for example, can be varied in this way. The support material is preferably dried under reduced pressure at from 100 to 800° C., preferably from 150 to 650° C., for from 1 to 10 hours before being used in the process of the present invention. If the inorganic metal oxide is silica, this is not reacted with an organosilane prior to step A). Such organosilanes are described in U.S. Pat. No. 4,374,753. In particular, no organosilanes of the formula (R₃Si)₂NH or RₙSiXₘ, where m and n are each 1, 2 or 3, the sum n+m=4, X is a group which can react with the OH groups of the silica and R is a hydrocarbon group consisting only of carbon and hydrogen, are used.

In general, the inorganic metal oxide has a mean particle diameter of from 5 to 200 μm, preferably from 10 to 100 μm and particularly preferably from 20 to 70 μm, an average pore volume of from 0.1 to 10 ml/g, in particular from 0.8 to 4.0 ml/g and particularly preferably from 0.8 to 2.5 ml/g, and a specific surface area of from 10 to 1000 m²/g, in particular from 50 to 900 m²/g, particularly preferably from 100 to 600 m²/g. The inorganic metal oxide can be spherical or granular and is preferably spherical.

The specific surface area and the mean pore volume are determined by nitrogen adsorption using the BET method, as described, for example, in S. Brunauer, P. Emmett and E. Teller in Journal of the American Chemical Society, 60, (1939), pages 209-319.

In another preferred embodiment, spray-dried silica gel is used as inorganic metal oxide. In general, the primary particles of the spray-dried silica gel have a mean particle diameter of from 1 to 10 μm, in particular from 1 to 5 μm. The primary particles are porous, granular silica gel particles which are obtained from an SiO₂ hydrogel by milling, if necessary after appropriate sieving. The spray-dried silica gel can then be produced by spray drying the primary particles slurried with water or an aliphatic alcohol. However, such a silica gel is also commercially available. The spray-dried silica gel which can be obtained in this way has voids or channels which have a mean diameter of from 1 to 10 μm, in particular from 1 to 5 μm, and whose macroscopic proportion by volume in the total particle is in the range from 5 to 20%, in particular in the range from 5 to 15%. These voids or channels usually have a positive influence on the diffusion-controlled access of monomers and cocatalysts and thus also on the polymerization kinetics.

The inorganic metal oxide is firstly reacted with a tetravalent titanium compound in step A). In this step, use is generally made of compounds of tetravalent titanium of the formula (R³O)ₜX²₄₋ₜTi, where the radical R³ is as defined for R and X² is as defined for X above and t is from 0 to 4. Examples of suitable compounds are tetraalkoxytitanium (t equals 4) such as tetramethoxytitanium, tetraethoxytitanium, tetrapropoxytitanium, tetraisopropoxytitanium, tetrabutoxytitanium or titanium(IV)-2-ethylhexoxide, trialkoxytitanium halides (t equals 3 and X² equals halide) such as titanium chloride triisopropoxide and titanium tetrahalides (t equals 0, X² equals halogen). Preference is given to titanium compounds in which X² is chlorine or bromine, particularly preferably chlorine. Very particular preference is given to using titanium tetrachloride.

Step A) can be carried out in any aprotic solvent. Particularly useful solvents are aliphatic and aromatic hydrocarbons in which the titanium compound is soluble, e.g. pentane, hexane, heptane, octane, dodecane, a benzene or a C₇-C₁₀-alkylbenzene such as toluene, xylene or ethylbenzene. A particularly preferred solvent is ethylbenzene.

The inorganic metal oxide is usually slurried in the aliphatic or aromatic hydrocarbon, and the titanium compound is added thereto. The titanium compound can be added as a pure substance or as a solution in an aliphatic or aromatic hydrocarbon, preferably pentane, hexane, heptane or toluene. However, it is also possible for example, to add the solution of the organometallic compound to the dry inorganic metal oxide. The titanium compound is preferably mixed with the solvent and subsequently added to the suspended inorganic metal oxide. The titanium compound is preferably soluble in the solvent. Reaction step A) can be carried out at from 0 to 150° C., preferably from 20 to 100° C.

The amount of titanium compound used is usually selected so as to be in the range from 0.1 to 20 mmol, preferably from 0.5 to 15 mmol and particularly preferably from 1 to 10 mmol, per gram of inorganic metal oxide.

It is also possible to add only part of the titanium compound, e.g. from 50 to 99% by weight of the total amount of the titanium compound to be used, in step A) and to add the remainder in one or more of the further steps. Preference is given to adding the total amount of the organometallic compound in step A).

In step B), the intermediate obtained from step A) is, usually without work-up or isolation, reacted with the magnesium compound MgR¹ₙX¹₂₋ₙ, where X¹ are each, independently of one another, fluorine, chlorine, bromine, iodine, hydrogen, R^{X}, NR^{X}₂, OR^{X}, SR^{X}, SO₃R^{X} or OC(O)R^{X}, and R¹ and R^{X} are each, independently of one another, a linear, branched or cyclic C₁-C₂₀ alkyl, a C₂-C₁₀-alkenyl, an alkylaryl having 1-10 carbon atoms in the alkyl part and 6-20 carbon atoms in the aryl part or a C₆-C₁₈-aryl and n is from 1 to 2. Mixtures of individual magnesium compounds MgR¹ₙX¹₂ₙ can also be used as magnesium compound MgR¹ₙX¹₂₋ₙ.

X¹ is as defined above for X. X¹ is preferably chlorine, bromine, methoxy, ethoxy, isopropoxy, butoxy or acetate.

R¹ and R^{X} are as defined above for R. In particular, R¹ are each, independently of one another, methyl, ethyl, n-propyl, isopropyl, n-butyl, sec-butyl, isobutyl, tert-butyl, n-pentyl, sec-pentyl, isopentyl, n-hexyl, n-heptyl, n-octyl, benzyl, o-, m-, p-methylbenzyl, 1- or 2-ethylphenyl, phenyl or 1-naphthyl.

Possible magnesium compounds are, in particular, alkylmagnesium halides, magnesium alkyls and magnesium aryls and also magnesium alkoxide and alkylmagnesium aryloxide compounds, with preference being given to using di(C₁-C₂₀-alkyl)magnesium compounds, in particular di(C₁-C₁₀-alkyl)magnesium compounds.

In a particularly preferred embodiment, use is made of magnesium compounds MgR¹₂, e.g. dimethylmagnesium, diethylmagnesium, dibutylmagnesium, dibenzylmagnesium, (butyl)(ethyl)magnesium or (butyl)(octyl)magnesium. These are useful because of, inter alia, their good solubility in nonpolar solvents. Particular preference is given to (n-butyl)(ethyl)magnesium and (butyl)(octyl)magnesium. In mixed compounds such as (butyl)(octyl)magnesium, the radicals R¹ can be present in various ratios, e.g. preference is given to using (butyl)_{1.5}(octyl)_{0.5}magnesium.

Suitable solvents for step B) are the same ones as for step A). Aliphatic and aromatic hydrocarbons in which the magnesium compound is soluble, e.g. pentane, hexane, heptane, octane, isooctane, nonane, dodecane, cyclohexane, benzene or a C₇-C₁₀-alkylbenzene such as toluene, xylene or ethylbenzene, are particularly useful. A particularly preferred solvent is heptane.

The intermediate obtained from step A) is usually slurried in the aliphatic and/or aromatic hydrocarbon, and the magnesium compound is added thereto. The magnesium compound can be added as a pure substance or, preferably, as a solution in an aliphatic or aromatic hydrocarbon, such as pentane, hexane, heptane or toluene. However, it is also possible to add the solution of the magnesium compound to the intermediate obtained from step A). The reaction is usually carried out at from 0 to 150° C., preferably from 30 to 120° C. and particularly preferably from 40 to 100° C.

The magnesium compound is usually used in an amount of from 0.1 to 20 mmol, preferably from 0.5 to 15 mmol and particularly preferably from 1 to 10 mmol, per gram of inorganic metal oxide. In general, the molar ratio of titanium compound used to magnesium compound used is in the range from 10:1 to 1:20, preferably from 1:1 to 1:3 and particularly preferably from 1:1.1 to 1:2.

The intermediate obtained from reaction step B) is, preferably without intermediate isolation, reacted with the halogenating reagent in step C).

Possible halogenating reagents are compounds of the formula R^{Y}ₛ-E-Y₄₋ₛ, where R^{Y} is, for example, hydrogen or a linear, branched or cyclic C₁-C₂₀-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl, where the radicals R^{Y} also being able to be substituted by chlorine or bromine, Y is chlorine or bromine, preferably chlorine, and s is 0, 1, 2 or 3. Examples of suitable compounds are alkylsilicon halides such as trichloromethylsilane, dichlorodimethylsilane or trimethylchlorosilane and alkyl halide and aryl halide compounds. Y is preferably chlorine. Particularly preferred halogenating reagents are alkyl halide compounds of the formula R^{Y}ₛ—C—Y₄₋ₛ, where R^{Y} is hydrogen or a linear, branched or cyclic C₁-C₂₀-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl, with the radicals R^{Y} also being able to be substituted by chlorine or bromine, Y is chlorine or bromine, preferably chlorine, and s is 0, 1, 2 or 3. Preferred halogenating reagents are alkyl halide compounds of the formula R^{Y}ₛ—C—Cl₄₋ₛ, such as methyl chloride, ethyl chloride, n-propyl chloride, n-butyl chloride, tert-butyl chloride, dichloromethane, chloroform or carbon tetrachloride. Very particular preference is given to alkyl halide compounds of the formula R^{Y}—C—Cl₃ in which R^{Y} is preferably hydrogen, methyl, ethyl, n-propyl, isopropyl, n-butyl, sec-butyl, isobutyl, tert-butyl, n-pentyl, sec-pentyl, isopentyl or n-hexyl. They give catalysts having particularly high productivities. Very particular preference is given to chloroform.

Suitable solvents for the reaction with the halogenating reagent are in principle the same ones as those for step A). The reaction is usually carried out at from 0 to 200° C., preferably from 20 to 150° C. and particularly preferably from 30 to 100° C.

In general, the molar ratio of halogenating reagent used to magnesium compounds used is in the range from 4:1 to 0.05:1, preferably from 3:1 to 0.5:1 and particularly preferably from 2:1 to 1:1. The magnesium compound can be partly or fully halogenated in this way. The magnesium compound is preferably fully halogenated.

The catalyst obtained from step C) can optionally be reacted with further reagents, for example with an alcohol of the formula R²—OH, where R² is a linear, branched or cyclic C₁-C₂₀-alkyl, a C₂-C₁₀-alkenyl, an alkylaryl having 1-10 carbon atoms in the alkyl part and 6-20 carbon atoms in the aryl part of a C₆-C₁₈-aryl, and/or a donor compound and/or an organometallic compound of elements of Group 3 of the Periodic Table.

The catalyst obtained from step C) or its reaction product with other reagents can also be reacted with one or more donor compounds, preferably one donor compound.

Suitable donor compounds possess at least one atom of Group 15 and/or 16 of the Periodic Table of the Elements, for example monofunctional or polyfunctional carboxylic acids, carboxylic anhydrides and carboxylic esters, also ketones, ethers, alcohols, lactones and organophosphorus and organosilicon compounds. Preference is given to using a donor compound which contains at least one nitrogen atom, preferably one nitrogen atom, for example monofunctional or polyfunctional carboxamides, amino acids, ureas, imines or amines. Preference is given to using one nitrogen-containing compound or a mixture of a plurality of nitrogen-containing compounds. Preference is given to amines of the formula NR⁴₂R⁵, where R⁴ and R⁵ are each, independently of one another, linear, branched or cyclic C₁-C₂₀-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl, C₂-C₂₀-alkenyl, which may be linear, cyclic or branched and in which the double bond can be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, C₆-C₂₀-aryl, which may bear alkyl groups as substituents, e.g. phenyl, naphthyl, biphenyl, anthranyl, o-, m-, p-methylphenyl, 2,3-, 2,4-, 2,5-, or 2,6-dimethylphenyl, 2,3,4-, 2,3,5-, 2,3,6-, 2,4,5-, 2,4,6- or 3,4,5-trimethylphenyl, or arylalkyl which may bear further alkyl groups as substituents, e.g. benzyl, o-, m-, p-methylbenzyl, 1- or 2-ethylphenyl where R⁴ and R⁵ may also be joined to form a 5- or 6-membered ring and the organic radicals R⁴ and R⁵ may also bear halogens such as fluorine, chlorine or bromine as substituents, or SiR⁶₃. Furthermore, R⁴ can also be hydrogen. Preference is given to amines in which one R⁴ is hydrogen. In organosilicon radicals SiR⁶₃, possible radicals R⁶ are the same radicals as have been described in detail above for R⁵, where two R⁶ may also be joined to form a 5- or 6-membered ring. Examples of suitable organosilicon radicals are trimethylsilyl, triethylsilyl, butyidimethylsilyl, tributylsilyl, triallylsilyl, triphenylsilyl and dimethylphenylsilyl. In a particularly preferred embodiment, use is made of amines of the formula HN(SiR⁶₃)₂ and in particular those in which R⁶ is a linear, branched or cyclic C₁-C₂₀-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl. Very particular preference is given to hexamethyldisilazane. Further preferred donors are carboxylic esters, in particular C₁-C₆-alkyl acetates, methyl acetate, ethyl acetate, propyl acetate or isopropyl acetate.

Suitable solvents for the reaction with the donor compound are the same ones as for step A). Aliphatic and aromatic hydrocarbons such as pentane, hexane, heptane, octane, dodecane, a benzene or a C₇-C₁₀-alkylbenzene such as toluene, xylene or ethylbenzene are particularly useful. A particularly preferred solvent is ethylbenzene. The donor compound is preferably soluble in the solvent. The reaction is usually carried out at from 0 to 150° C., preferably from 0 to 100° C. and particularly preferably from 20 to 70° C.

If such a donor compound is used in the formulation, the molar ratio of titanium compound used to donor compound used is generally in the range from 1:100 to 1:0.05, preferably from 1:10 to 1:0.1 and particularly preferably from 1:1 to 1:0.4.

The catalyst obtained from step C) or a variant thereof which has been modified further can optionally be reacted with further reagents, for example, with an alcohol of the formula R²—OH, where R² is a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl, and/or an organometallic compound of an element of Group 3 of the Periodic Table.

Suitable alcohols are, for example, methanol, ethanol, 1-propanol, 2-propanol, 1-butanol, 2-butanol, 1-pentanol, 2-pentanol, 1-hexanol, 2-ethylhexanol, 2,2-dimethylethanol or 2,2-dimethylpropanol, in particular ethanol, 1-propanol, 1-butanol, 1-pentanol, 1-hexanol or 2-ethylhexanol.

Suitable solvents for the reaction with alcohol are the same ones as for step A). The reaction is usually carried out at from 0 to 150° C., preferably from 20 to 100° C. and particularly preferably from 60 to 100° C.

If an alcohol is used in the formulation, the molar ratio of alcohol used to magnesium compound used is usually in the range from 0.01:1 to 20:1, preferably from 0.05:1 to 10:1 and particularly preferably from 0.1:1 to 1:1.

Furthermore, the catalyst obtained from step C) or its reaction product with other reagents can also be brought into contact with an organometallic compound MRₘX₃₋ₘ of a metal of Group 3 of the Periodic Table of the Elements, where X are each, independently of one another, fluorine, chlorine, bromine, iodine, hydrogen, NR^{X}₂, OR^{X}, SR^{X}, SO₃R^{X} or OC(O)R^{X}, and R and R^{X} are each, independently of one another, a linear, branched or cyclic, C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl, M is a metal of Group 3 of the Periodic Table, preferably B, Al or Ga and particularly preferably Al, and m is 1, 2 or 3.

R are each, independently of one another, a linear, branched or cyclic C₁-C₂₀-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl, n-nonyl, n-decyl or n-dodecyl, cyclopropyl, cyclobutyl, cyclopentyl, cyclohexyl, cycloheptyl, cyclooctyl, cyclononyl or cyclododecyl, a C₂-C₁₀-alkenyl, which may be linear, cyclic or branched and in which the double bond can be internal or terminal, e.g. vinyl, 1-allyl, 2-allyl, 3-allyl, butenyl, pentenyl, hexenyl, cyclopentenyl, cyclohexenyl, cyclooctenyl or cyclooctadienyl, an alkylaryl having 1-10 carbon atoms in the alkyl part and 6-20 carbon atoms in the aryl part, e.g. benzyl, o-, m-, p-methylbenzyl, 1- or 2-ethylphenyl, or a C₆-C₁₈-aryl which may bear further alkyl groups as substituents, e.g. phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, 2-biphenyl, o-, m-, p-methylphenyl, 2,3-, 2,4-, 2,5-, or 2,6-dimethylphenyl, 2,3,4-, 2,3,5-, 2,3,6-, 2,4,5-, 2,4,6- or 3,4,5-trimethylphenyl, where two R may also be joined to form a 5- or 6-membered ring and the organic radicals R may also be substituted by halogens such as fluorine, chlorine, or bromine.

X are each, independently of one another, fluorine, chlorine, bromine, iodine, hydrogen, amide NR^{X}₂, alkoxide OR^{X}, thiolate SR^{X}, sulfonate SO₃R^{X} or carboxylate OC(O)R^{X}, where R^{X} is as defined for R. NR^{X}₂ can be, for example, dimethylamino, diethylamino or diisopropylamino, OR^{X} can be methoxy, ethoxy, isopropoxy, butoxy, hexoxy, or 2-ethylhexoxy, SO₃R^{X} can be methylsulfonate, trifluoromethylsulfonate or toluenesulfonate and OC(O)R^{X} can be formate, acetate or propionate.

As organometallic compound of an element of Group 3 of the Periodic Table, preference is given to using an aluminum compound AlRₘX₃₋ₘ, where the variables are as defined above. Examples of suitable compounds are trialkylaluminum compounds such as trimethylaluminum, triethylaluminum, triisobutylaluminum or tributylaluminum, dialkylaluminum halides such as dimethylaluminum chloride, diethylaluminum chloride or dimethylaluminum fluoride, alkylaluminum dihalides such as methylaluminum dichloride or ethylaluminum dichloride, or mixtures such as methylaluminum sesquichloride. The reaction products of aluminum alkyls with alcohols can also be used. Preferred aluminum compounds are those in which X Is chlorine. Among these aluminum compounds, particular preference is given to those in which m is 2. Preference is given to using dialkylaluminum halides AlR₂X, where X is halogen and in particular chlorine and R is, in particular, a linear, branched or cyclic C₁-C₂₀-alkyl. Very particular preference is given to using dimethylaluminum chloride or diethylaluminum chloride.

Suitable solvents for the reaction with the organometallic compound MRₘX₃₋ₘ of a metal of Group 3 of the Periodic Table of the Elements are the same ones as for step A). Aliphatic and aromatic hydrocarbons in which the organometallic compound of an element of Group 3 of the Periodic Table is soluble, e.g. pentane, hexane, heptane, octane, dodecane, a benzene, or a C₇-C₁₀-alkylbenzene such as toluene, xylene or ethylbenzene, are particularly useful. A particularly preferred solvent is ethylbenzene. The reaction is usually carried out at from 20 to 150° C., preferably from 40 to 100° C.

If an organometallic compound of a metal of Group 3 of the Periodic Table of the Elements is employed in the formulation, it is usually used in an amount of from 0.005 to 100 mmol, preferably from 0.05 to 5 mmol and particularly preferably from 0.1 to 1 mmol, per gram of inorganic metal oxide.

A preferred process for preparing catalyst systems of the Ziegler-Natta type comprises the following steps:
A) bringing an inorganic metal oxide into contact with a tetravalent titanium compound and
B) bringing the intermediate obtained from step A) into contact with a magnesium compound MgR¹ₙX¹₂₋ₙ where X¹ are each, Independently of one another, fluorine, chlorine, bromine, iodine, hydrogen, NR^{X}₂, OR^{X}, SR^{X}, SO₃R^{X} or OC(O)R^{X}, and R¹ and R^{X} are each, independently of one another, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl and n is 1 or 2,
C) bringing the intermediate obtained from step B) into contact with a halogenating reagent of the formula R^{Y}ₛ-E-Y₄₋ₛ, where R^{Y} are each, independently of one another, hydrogen, a linear, branched or cyclic C₁-C₂₀ alkyl, a C₂-C₁₀-alkenyl, an alkylaryl having 1-10 carbon atoms in the alkyl part and 6-20 carbon atoms in the aryl part or a C₆-C₁₈-aryl, E is carbon or silicon, Y is fluorine, chlorine, bromine or iodine and s is 0, 1, 2 or 3 when E is carbon and s is 1, 2 or 3 when E is silicon, and
D) optionally bringing the intermediate obtained from step C) into contact with a donor compound.

Preference is given to a process consisting of the steps A), B), C) and optionally D). Particular preference is given to a process consisting of the steps A), B), C) and D). The preferred embodiments of the compounds and reaction steps also apply in these preferred processes.

The intermediate obtained from step C) is usually reacted without intermediate isolation with one or more donor compounds, preferably one donor compound.

The intermediate obtained from step C) is usually slurried with a solvent, and the donor compound is added thereto. However, it is also possible, for example, to dissolve the donor compound in the solvent and subsequently to add the solution to the intermediate obtained from step C). The donor compound is preferably soluble in the solvent.

Subsequent thereto or between the reactions with the various reagents, the catalyst system or an intermediate obtained in this way can be washed one or more times with an aliphatic or aromatic hydrocarbon such as pentane, hexane, heptane, octane, nonane, decane, dodecane, cyclohexane, benzene or a C₇-C₁₀-alkylbenzene such as toluene, xylene or ethylbenzene. Preference is given to using aliphatic hydrocarbons, in particular pentane, n-hexane or isohexane, n-heptane or isoheptane. This is usually carried out at from 0 to 200° C., preferably from 0 to 150° C. and particularly preferably from 20 to 100° C., for from 1 minute to 20 hours, preferably from 10 minutes to 10 hours and particularly preferably from 30 minutes to 5 hours. In this procedure, the catalyst is stirred with the solvent and then filtered off. This step can be repeated once or twice. Instead of a plurality of successive washing steps, the catalyst can also be washed by extraction, e.g. in a Soxhlett apparatus, which achieves continuous washing.

Step C) or D) or the optional reactions or the last washing step is preferably followed by a drying step in which all or part of the residual solvent is removed. The novel catalyst system obtained in this way can be completely dry or have a certain residual moisture content. However, the amount of volatile constituents should be not more than 20% by weight, in particular not more than 10% by weight, based on the catalyst system.

The novel catalyst system obtainable in this way or its preferred embodiments advantageously has/have a titanium content of from 0.1 to 30% by weight, preferably from 0.5 to 10% by weight and particularly preferably from 0.7 to 3% by weight, and a magnesium content of from 0.1 to 30% by weight, preferably from 0.5 to 20% by weight and particularly preferably from 0.8 to 6% by weight, in each case based on the catalyst system.

It is also possible firstly to prepolymerize the catalyst system with α-olefins, preferably linear C₂-C₁₀-1-alkenes and in particular ethylene or propylene, and then to use the resulting prepolymerized catalyst solid in the actual polymerization. The mass ratio of catalyst solid used in the prepolymerization to monomer polymerized onto it is usually in the range from 1:0.1 to 1:200.

Furthermore, a small amount of an olefin, preferably an α-olefin, for example vinyl cyclohexane, styrene or phenyldimethylvinylsilane, as modifying component, an antistatic or a suitable inert compound such as a wax or oil can be added as additive during or after the preparation of the supported catalyst system. The molar ratio of additives to transition metal compound B) is usually from 1:1000 to 1000:1, preferably from 1:5 to 20:1.

The process for the polymerization or copolymerization of olefins in the presence of at least one catalyst system according to the present invention and, if appropriate, an aluminum compound as cocatalyst is carried out at from 20 to 150° C. and pressures of from 1 to 100 bar.

The process of the invention for the polymerization of olefins can be combined with all industrially known polymerization processes at from 20 to 150° C. and under pressures of from 1 to 100 bar, in particular from 5 to 50 bar. The advantageous pressure and temperature ranges for carrying out the process therefore depend greatly on the polymerization method. Thus, the catalyst systems used according to the present invention can be employed in all known polymerization processes, in a known manner in bulk, in suspension, in the gas phase or in a supercritical medium in the customary reactors used for the polymerization of olefins, for example in suspension polymerization processes, in solution polymerization processes, in stirred gas-phase processes or in gas-phase fluidized-bed processes. The process can be carried out batchwise or preferably continuously in one or more stages.

Among the polymerization processes mentioned, gas-phase polymerization, in particular in gas-phase fluidized-bed reactors, solution polymerization and suspension polymerization, in particular in loop reactors and stirred tank reactors, are preferred. The suitable gas-phase fluidized-bed processes are described in detail in, for example, EP-A-004645, EP-A-089691, EP-A-120503 or EP-A-241947. The gas-phase polymerization can also be carried out in the condensed or super-condensed mode in which part of the circulating gas is cooled to below the dew point and returned as a two-phase mixture to the reactor. It is also possible to use a reactor having two or more polymerization zones. In preferred reactors, the two polymerization zones are linked to one another and the polymer is alternately passed through these two zones a plurality of times, with the two zones also being able to have different polymerization conditions. Such a reactor is described, for example, In WO 97/04015. Different or even identical polymerization processes can also, if desired, be connected in series so as to form a polymerization cascade, for example as in the Hostalen process. It is also possible to carry out two or more identical or different processes in parallel reactors.

The Ziegler catalysts of the present invention can also be carried out by means of combinatorial methods or be tested for polymerization activity with the aid of these combinatorial methods.

The molar mass of the polyalk-1-enes formed in this way can be controlled and adjusted over a wide range by addition of regulators customary in polymerization technology, for example hydrogen. Furthermore, further customary additives such as antistatics can also be used in the polymerizations. In addition, the product output can be varied via the amount of Ziegler catalyst metered in. The (co)polymers produced can then be conveyed to a deodorization or deactivation vessel in which they can be subjected to a customary and known treatment with nitrogen and/or steam.

In low-pressure polymerization processes, the temperature set is generally at least a few degrees below the softened temperature of the polymer. In particular, temperatures in the range from 50 to 150° C., preferably from 70 to 120° C., are set in these polymerization processes. In suspension polymerizations, the polymerization is usually carried out in a suspension medium, preferably in an inert hydrocarbon such as isobutane, or else in the monomers themselves. The polymerization temperatures are generally in the range from 20 to 115° C., and the pressure is generally in the range from 1 to 100 bar, in particular from 5 to 40 bar. The solids content of the suspension is generally in the range from 10 to 80%.

Various olefinically unsaturated compounds can be polymerized by the process of the present invention; for the purposes of the invention, the term polymerization encompasses copolymerization. Possible olefins include ethylene and linear or branched x-olefins having from 3 to 12 carbon atoms, e.g. propene, 1-butene, 1-pentene, 1-hexene, 1-heptene, 1-octene, 1-nonene, 1-decene, 1-dodecene or 4-methyl-1-pentene, and also nonconjugated and conjugated dienes such as a butadiene, 1,5-hexadiene or 1,6-heptadiene, cyclic olefins such as cyclohexene, cyclopentene or norbornene and polar monomers such as acrylic esters, acrylamides, acrolein, acrylonitrile, ester or amide derivatives of methacrylic acid, vinyl ethers, allyl ethers and vinyl acetate. It is also possible to polymerize mixtures of various α-olefins. Vinyl aromatic compounds such as styrene can also be polymerized by the process of the present invention. Preference is given to polymerizing at least one α-olefin selected from the group consisting of ethene, propene, 1-butene, 1-pentene, 1-hexene, 1-heptene, 1-octene and 1-decene, in particular ethene. Mixtures of three or more olefins can also be copolymerized. In a preferred embodiment of the process of the present invention, ethylene is polymerized or ethylene is copolymerized with C₃-C₈-α-monoolefins, in particular ethylene with C₃-C₈-α-olefins. In a further preferred embodiment of the process of the present invention, ethylene is copolymerized together with an α-olefin selected from the group consisting of propene, 1-butene, 1-pentene, 1-hexene, 1-heptene and 1-octene.

Some of the catalyst systems have little or no polymerization activity on their own and are then brought into contact with an aluminum compound as cocatalyst in order to be able to display good polymerization activity. Aluminum compounds suitable as cocatalyst are, in particular, compounds of the formula AlR⁷ₘX³₃₋ₘ, where R⁷ is as defined above for R and X³ is as defined above for X and m is 1, 2 or 3. Apart from trialkylaluminums, compounds in which one or two alkyl groups have been replaced by alkoxy groups, in particular C₁-C₁₀-dialkylaluminum alkoxides such as diethylaluminum ethoxide, or by one or two halogen atoms, for example chlorine or bromine, in particular dimethylaluminum chloride, methylaluminum dichloride, methylaluminum sesquechloride or diethylaluminum chloride, are useful as cocatalysts. Preference is given to using trialkylaluminum compounds whose alkyl groups each have from 1 to 15 carbon atoms, for example trimethylaluminum, methyldiethylaluminum, triethylaluminum, triisobutylaluminum, tributylaluminum, trihexylaluminum or trioctylaluminum. It is also possible to use cocatalysts of the aluminoxane type, in particular methylaluminoxane MAO. Aluminoxanes are prepared, for example, by controlled addition of water to alkylaluminum compounds, in particular trimethylaluminum. Aluminoxane preparations suitable as cocatalyst are commercially available.

The amount of aluminum compounds to be used depends on their effectiveness as cocatalysts. Since many of the cocatalysts are simultaneously used for the removal of catalyst poisons (scavengers), the amount used depends on the level of contamination of the other starting materials. However, a person skilled in the art can determine the optimum amount by simple experimentation. The cocatalyst is preferably used in such an amount that the atomic ratio of aluminum from the aluminum compound used as cocatalyst and titanium from the catalyst system of the present invention is from 10:1 to 800:1, in particular from 20:1 to 200:1.

The various aluminum compounds can be used as cocatalyst either individually or as a mixture of two or more components in any order. Thus, these aluminum compounds serving as cocatalysts can be allowed to act on the catalyst systems of the present invention either in succession or together. The catalyst system of the present invention can be brought into contact with the cocatalyst or cocatalysts either before or after it is brought into contact with the olefins to be polymerized. Preactivation using one or more cocatalysts prior to mixing with the olefin and further addition of the same or other cocatalysts after the preactivated mixture has been brought into contact with the olefin is also possible. Preactivation is usually carried out at from 0 to 150° C., in particular from 20 to 80° C., and pressures of from 1 to 100 bar, in particular from 1 to 40 bar.

To obtain a broad product spectrum, the catalyst systems of the present invention can also be used in combination with at least one catalyst customary for the polymerization of olefins. Possible catalysts here are, in particular, Phillips catalysts based on chromium oxides, metallocenes (e.g. EP-A-129368), constrained geometry complexes (e.g. EP-A-0416815 or EP-A-0420436), nickel and palladium bisimine systems (for preparation of these, see WO-A-98/03559), iron and cobalt pyridinebisimine compounds (for preparation of these, see WO-A-98/27124) or chromium amides (cf. for example, 95JP-170947). Further suitable catalysts are metallocenes having at least one ligand based on a cyclopentadienyl or heterocyclodienyl having a fused-on heterocycle, where the heterocycles are preferably aromatic and contain nitrogen and/or sulfur. Such compounds are described, for example, in WO 98/22486. Further suitable catalysts are substituted monocyclopentadienyl, monoindenyl, monofluorenyl or heterocyclopentadienyl complexes of chromium in which at least one of the substituents on the cyclopentadienyl ring bears a donor function. Furthermore, in addition to the catalysts, it is possible to add a further cocatalyst whose addition enables the catalysts to be active in the olefin polymerization. These are preferably cation-forming compounds. Suitable cation-forming compounds are, for example, aluminoxane-type compounds, strong uncharged Lewis acids, in particular tris(pentafluorophenyl)borane, ionic compounds having a Lewis-acid cation or ionic compounds containing Brönsted acids as cations, in particular, N,N-di-methylanilinium tetrakis(pentafluorophenyl)borate and especially N,N-dimethylcyclohexylammonium tetrakis(pentafluorophenyl)borate or N,N-dimethylbenzylammonium tetrakis(pentafluorophenyl)borate. Such combinations with the catalysts make it possible, for example, to produce bimodal products or to generate comonomers in situ. For this purpose, the catalyst system of the present invention is preferably used in the presence of at least one catalyst customary for the polymerization of olefins and, if desired, one or more cocatalysts. The catalyst customary for the polymerization of olefins can have been applied to the same inorganic metal oxide or be immobilized on another support material and be used simultaneously or in any order with the catalyst system of the present invention.

The process of the present invention makes it possible to prepare polymers of olefins having molar masses in the range from about 10000 to 5000000, preferably 20000 to 1000000, with polymers having molar masses (weight average) in the range from 20 000 to 400 000 being particularly preferred.

The catalyst systems of the present invention are particularly well-suited to preparing ethylene homopolymers and copolymers of ethylene with α-olefins. Thus, homopolymers of ethylene or copolymers of ethylene with C₃-C₁₂-α-olefins containing up to 10% by weight of comonomer in the copolymer can be prepared. Preferred copolymers contain from 0.3 to 1.5 mol % of 1-hexene or 1-butene, based on the polymer, and particularly preferably from 0.5 to 1 mol % of 1-hexene or 1-butene.

The bulk densities of the ethylene homopolymers and copolymers of ethylene with α-olefins which are obtainable in this way are in the range from 240 to 590 g/l, preferably from 245 to 550 g/l.

In particular, ethylene homopolymers having densities of 0.95-0.96 g/cm³ and copolymers of ethylene with C₄-C₈-α-olefins, in particular ethylene-hexene copolymers and ethylene-butene copolymers, having a density of 0.92-0.94 g/cm³; a polydispersity M_{w}/Mₙ of from 3 to 8, preferably from 4.5 to 6, can be obtained using the catalyst system of the present invention. The proportion of material which can be extracted from the homopolymers and copolymers of ethylene by cold heptane is usually in the range from 0.01 to 3% by weight, preferably from 0.05 to 2% by weight, based on the ethylene polymer used.

The polymer prepared according to the present invention can also form mixtures with other olefin polymers, in particular homopolymers and copolymers of ethylene. These mixtures can be prepared by the above-described simultaneous polymerization over a plurality of catalysts or they can be prepared simply by subsequent blending of the polymers prepared according to the present invention with other homopolymers or copolymers of ethylene.

The polymers, ethylene copolymers, polymer mixtures and blends can further comprise auxiliaries and/or additives known per se, e.g. processing stabilizers, stabilizers against the action of light and heat, customary additives such as lubricants, antioxidants, antiblocking agents and antistatics, and also, if appropriate, colorants. The type and amount of these additives is known to those skilled in the art.

The polymers prepared according to the present invention can also be modified subsequently by grafting, crosslinking, hydrogenation or other functionalization reactions known to those skilled in the art.

Owing to the good mechanical properties, the polymers and copolymers of olefins, in particular homopolymers and copolymers of ethylene, prepared using the catalyst systems of the present invention are particularly suitable for the production of films, fibers and moldings.

The catalyst systems of the present invention are very useful for preparing homopolymers and copolymers of ethylene. They give high productivities, even at high polymerization temperatures. The catalysts display good incorporation of comonomers and the molar masses of the polymers can readily be regulated by means of hydrogen.

### EXAMPLES AND COMPARATIVE EXAMPLES

The parameters listed in the tables were determined by the following measurement methods:

Density: in accordance with ISO 1183

MI: Melt flow index (190° C./2.16) in accordance with ISO 1133

The determination of the molar mass distributions and the means Mₙ, M_{w} and M_{w}/Mₙ derived therefrom was carried out by means of high-temperature gel permeation chromatography (GPC) using a method based on DIN 55672 under the following conditions: solvent: 1,2,4-trichlorobenzene, flow: 1 ml/min, temperature: 140° C., calibration using PE standards.

The cold heptane extractables were determined by stirring 10 g of the polymer powder in 50 ml of heptane at 23° C. for 2 h. The polymer was filtered off from the extract obtained in this way and washed with 100 ml of heptane. The combined heptane phases were freed of the solvent and dried to constant weight. The residue is weighed and is the cold heptane extractables.

The Staudinger Index (η)[dl/g] was determined at 130° C. using an automatic Ubbelohde Viscometer (Lauda PVS 1) and decalin as solvent (ISO1628 at 130° C., 0.001 g/ml of decalin).

Determination of the content of the elements magnesium and aluminum:

The content of the elements magnesium and aluminum was determined on samples digested in a mixture of concentrated nitric acid, phosphoric acid and sulfuric acid using an inductively coupled plasma atomic emission spectrometer (ICP-AES) from Spectro, Kleve, Germany, by means of the spectral lines at 277.982 nm for magnesium and 309.271 nm for aluminum. The titanium content was determined on samples digested in a mixture of 25% strength sulfuric acid and 30% strength hydrogen peroxide by means of the spectral line at 470 nm.

### Example 1

In a first step, 25.6 g of finely divided spray-dried silica gel ES 70× from Crossfield which had been dried at 600° C. was suspended in 200 ml of heptane, heated to 80° C. and admixed while stirring with a solution of 3.39 ml of titanium tetrachloride in 10 ml of heptane. The suspension obtained in this way was refluxed at 100° C. for 2 hours; cooled to room temperature, the solid was filtered off and washed twice with heptane. The solid obtained in this way was resuspended in 100 ml of heptane and admixed with 35.84 ml of (n-butyl)_{1.5}(octyl)_{0.5}magnesium (0.875 M in n-heptane). This suspension was stirred at 80° C. for 2 hours, cooled to room temperature, the solid was filtered off and washed twice with heptane. This solid was resuspended in 100 ml of heptane, 5.12 ml of methylene chloride were added and the mixture was subsequently stirred at 80° C. for 1.5 hours. The solid obtained in this way was filtered off, washed with heptane and dried at 60° C. under reduced pressure. This gave 31.1 g of the catalyst system having a magnesium content of 2.5% by weight, an aluminum content of less than 0.1% by weight, a chlorine content of 10.75% by weight and a titanium content of 3.1% by weight, in each case based on the finished catalyst system.

### Example 2

In a first step, 51.8 g of finely divided spray-dried silica gel ES 70× from Crossfield which had been dried at 600° C. was suspended in 300 ml of ethylbenzene, heated to 80° C. and admixed while stirring with a solution of 6.86 ml of titanium tetrachloride in 10 ml of ethylbenzene. The suspension obtained in this way was stirred at 100° C. for 2 hours, cooled to room temperature, the solid was filtered off and washed twice with ethylbenzene. The solid obtained in this way was resuspended in 200 ml of ethylbenzene and admixed with 72.52 ml of (n-butyl)_{1.5}(octyl)_{0.5}magnesium (0.875 M in n-heptane) in 130 ml of ethylbenzene. This suspension was stirred at 80° C. for 1 hour, cooled to room temperature, the solid was filtered off and washed twice with ethylbenzene. This solid was resuspended in 200 ml of ethylbenzene, 10.36 ml of chloroform dissolved in 20 ml of ethylbenzene were added and the mixture was subsequently stirred at 80° C. for 1.5 hours. The solid obtained in this way was filtered off, washed with heptane and dried at 60° C. under reduced pressure. This gave 102 g of the catalyst system having a magnesium content of 2.2% by weight, an aluminum content of less than 0.1% by weight, a chlorine content of 11.75% by weight and a titanium content of 3.0% by weight, in each case based on the finished catalyst system.

### Example 3 (Comparative Example)

100.3 g of finely divided spray-dried silica gel ES 70× from Crossfield which had been dried at 600° C. were suspended in 450 ml of ethylbenzene, heated to 80° C. and admixed while stirring with 13.23 ml of titanium tetrachloride in 30 ml of ethylbenzene. The suspension obtained in this way was stirred at 100° C. for 1.5 hours, cooled to room temperature, the solid was filtered off and washed twice with ethylbenzene. The solid obtained in this way was resuspended in 200 ml of ethylbenzene and admixed with 137.6 ml of (n-butyl)_{1.5}(octyl)_{0.5}magnesium (0.875 M in n-heptane) in 150 ml of ethylbenzene. The suspension was stirred at 80° C. for 1 hour, cooled to room temperature, the solid was filtered off and washed twice with ethylbenzene. This solid was resuspended in 200 ml of ethylbenzene, 27.63 ml of tetrachlorosilane dissolved in 30 ml of ethylbenzene were added and the mixture was subsequently stirred at 80° C. for 1.5 hours. The solid obtained in this way was filtered off, washed with heptane and dried at 60° C. under reduced pressure. This gave 129.9 g of the catalyst system having a magnesium content of 2.15% by weight, an aluminum content of less than 0.1% by weight, a chlorine content of 10.05% by weight and a titanium content of 3.1% by weight, in each case based on the finished catalyst system.

### Example 4 (Comparative Example)

45 g of finely divided spray-dried silica gel ES 70× from Crossfield, which had been dried at 600° C. was suspended in 250 ml of ethylbenzene, heated to 80° C. and admixed while stirring with a solution of 5.96 ml of titanium tetrachloride in 30 ml of ethylbenzene. The suspension obtained in this way was stirred at 100° C. for 2 hours, cooled to room temperature, the solid was filtered off and washed twice with ethylbenzene. The solid obtained in this way was resuspended in 200 ml of ethylbenzene and admixed with 61.7 ml of (n-butyl)_{1.5}(octyl)_{0.5}magnesium (0.875 M in n-heptane) in 300 ml of ethylbenzene. This suspension was stirred at 80° C. for 1 hour, cooled to room temperature, the solid was filtered off and washed twice with ethylbenzene. This solid was resuspended in 200 ml of ethylbenzene, treated with HCl gas at atmospheric pressure for 1 hour and subsequently stirred at 80° C. for 1 hour. The solid obtained in this way was filtered off, washed with heptane and dried at 60° C. under reduced pressure. This gave 55.7 g of the catalyst system.

### Examples 5 and 6

Polymerization

The polymerizations were carried out in a 10 l stirring autoclave. Under nitrogen, 1 g of TEAL (triethylaluminum) together with 4 l of isobutane and 1 l of butene were introduced into the autoclave at room temperature. The autoclave was then pressurized with 4 bar of H₂ and 16 bar of ethylene, the weight of catalyst indicated in Table 1 was introduced and polymerization was carried out at an internal reactor temperature of 70° C. for 1 hour. The reaction was stopped by venting. Table 1 shows the productivity of the catalyst systems from examples 2 and 3 and the density and the η value of the ethylene-butene copolymers obtained both for example 5 according to the present invention and for comparative example 6.

TABLE 1
Polymerization results

| | | | | Productivity | | |
|---|---|---|---|---|---|---|
| | Catalyst | Weight used | Yield | [g of PE/g | η | Density |
| Ex. | from ex. | [mg] | [g of PE] | of cat] | [dl/g] | [g/cm³] |
| 5 | 2 | 130 | 450 | 3461 | 1.48 | 0.9252 |
| 6 | 3 (C) | 283 | 180 | 636 | 2.04 | 0.9335 |

### Examples 7 to 10

Polymerization

200 mg of triisobutylaluminum (dissolved in hexane) and 18 ml of hexane were introduced into a 1.4 l stirring autoclave which had been provided with an initial charge of 150 g of polyethylene and made inert by means of argon. The weight of catalyst indicated in Table 2 was then introduced, the autoclave was pressurized with 9 bar of N₂, 1 bar of H₂ and 10 bar of ethylene, the reaction mixture was brought to 110° C. and polymerized at an internal reactor temperature of 110° C. for 1 hour. The reaction was stopped by venting.

Table 2 below shows the productivity of the catalysts used both for Examples 7 and 8 according to the present invention and for comparative examples 9 and 10.

TABLE 2
Polymerization results

| | Catalyst from | Weight used | Yield | Productivity |
|---|---|---|---|---|
| Ex. | Ex. | [mg] | [gPE] | [g of PE/g of cat] |
| 7 | 1 | 73 | 63 | 863 |
| 8 | 2 | 78 | 104 | 1333 |
| 9 | 3 (C) | 79 | 43 | 544 |
| 10 | 4 (C) | 75 | 57 | 760 |

1. A process for preparing catalyst systems of the Ziegler-Natta type, which comprises the following steps:
A) bringing an inorganic metal oxide into contact with a tetravalent titanium compound and
B) bringing the intermediate obtained from step A) into contact with a magnesium compound MgR¹ₙX¹₂₋ₙ, where X¹ are each, independently of one another, fluorine, chlorine, bromine, iodine, hydrogen, NR^{X}₂, OR^{X}, SR^{X}, SO₃R^{X} or OC(O)R^{X}, and R¹ and R^{X} are each, independently of one another, a linear, branched or cyclic C₁-C₂₀-alkyl, a C₂-C₁₀-alkenyl, an alkylaryl having 1-10 carbon atoms in the alkyl part and, 6-20 carbon atoms in the aryl part or a C₆-C₁₈-aryl and n is 1 or 2,
C) bringing the intermediate obtained from step B) into contact with a halogenating reagent of the formula R^{Y}ₛ-E-Y₄₋ₛ, where R^{Y} are each, independently of one another, hydrogen, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl, E is carbon or silicon, Y is fluorine, chlorine, bromine or iodine and s is 0, 1, 2 or 3 when E is carbon and s is 1, 2 or 3 when E is silicon.

2. A process for preparing catalyst systems as claimed in claim 1, wherein a magnesium compound MgR¹₂ is used in step B).

3. A process for preparing catalyst systems as claimed in claim 1, wherein the halogenating reagent used in step C) is chloroform.

4. A process for preparing catalyst systems as claimed in claim 1, wherein the inorganic metal oxide used in step A) is a silica gel.

5. A process for preparing catalyst systems as claimed in claim 1, wherein the tetravalent titanium compound used in step A) is titanium tetrachloride.

6. A process for preparing catalyst systems as claimed in claim 1, which comprises the following steps:
A) bringing an inorganic metal oxide into contact with a tetravalent titanium compound
B) bringing the intermediate obtained from step A) into contact with a magnesium compound MgR¹ₙX¹₂₋ₙ, where X¹ are each, independently of one another, fluorine, chlorine, bromine, iodine, hydrogen, NR^{X}₂, OR^{X}, SR^{X}, SO₃R^{X} or OC(O)R^{X}, and R¹ and R^{X} are each, independently of one another, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl and n is 1 or 2.
C) bringing the intermediate obtained from step B) into contact with a halogenating reagent of the formula R^{Y}ₛ-E-Y₄₋ₛ, where R^{Y} are each, independently of one another, hydrogen, a linear, branched or cyclic C₁-C₂₀-alkyl, a C₂-C₁₀-alkenyl, an alkylaryl having 1-10 carbon atoms in the alkyl part and 6-20 carbon atoms in the aryl part or a C₆-C₁₈-aryl, E is carbon or silicon, Y is fluorine, chlorine, bromine or iodine and s is 0, 1, 2 or 3 when E is carbon and s is 1, 2 or 3 when E is silicon, and
D) optionally bringing the intermediate obtained from step C) into contact with a donor compound.

7. A process for preparing catalyst systems as claimed in claim 6, wherein the donor compound used in step D) contains at least one nitrogen atom.

8. A catalyst system of the Ziegler-Natta type which can be prepared by a process as claimed in claim 1.

9. A prepolymerized catalyst system comprising a catalyst system as claimed in claim 7 and linear C₂-C₁₀-1-alkenes polymerized onto it in a mass ratio of from 1:0.1 to 1:200.

10. A process for the polymerization or copolymerization of olefins at from 20 to 150° C. and pressures of from 1 to 100 bar in the presence of at least one catalyst system as claimed in claim 8 and, if appropriate, an aluminum compound as cocatalyst.

11. A process for the polymerization or copolymerization of olefins as claimed in claim 10, wherein a trialkylaluminum compound whose alkyl groups each have from 1 to 15 carbon atoms is used as aluminum compound.

12. A process for the polymerization or copolymerization of olefins as claimed in claim 10, wherein ethylene or a mixture of ethylene and C₃-C₈-α-monoolefins is (co)polymerized.

13. The use of a catalyst system as claimed in claim 8 for the polymerization or copolymerization of olefins.
